(19) United States
(12) Patent Application Publication
(10) Pub. No.: US 2023/0044644 A1
(43) Pub. Date: Feb. 9, 2023

(54) LARGE-SCALE GENERATION OF PHOTOREALISTIC 3D MODELS

(71) Applicant: Datagen Technologies, Ltd., Tel Aviv (IL)

(72) Inventor: Gil ELBAZ, Caesarea (IL)

(21) Appl. No.: 17/791,455

(22) PCT Filed: Jan. 6, 2021
(86) PCT No.: PCT/IL2021/050020

§ 371 Date: Jul. 7, 2022

Related U.S. Application Data
(60) Provisional application No. 62/958,807, filed on Jan. 9, 2020.

(51) Int. Cl. G06T 17/20; G06T 15/04; G06T 9/00

(52) U.S. Cl. CPC G06T 17/20; G06T 15/04; G06T 9/002; G06T 2200/08

(57) ABSTRACT

A system and methods are provided for large-scale generation of photorealistic 3D models, including training texture map and 3D mesh encoder and decoder neural networks, and training a sampler neural network to convert random seeds into input vectors for the texture map and 3D mesh decoder networks. Training the sampler neural network may include feeding random seeds to the sampler neural network, generating training 3D models from the texture map and 3D mesh decoders, rendering 2D images from the training 3D models, back-propagating output of realism classifier and of a uniqueness function of the 2D images to the sampler neural network; and providing the trained sampler neural network with additional random seed inputs to generate multiple respective input vectors for the texture map and 3D mesh decoders, and responsively generating by the texture map and 3D mesh decoders multiple new 3D models.

### FIELD OF THE INVENTION

The present invention relates generally to the field of artificial intelligence and in particular to image generation.

### BACKGROUND

Recently, there has been a rapid advance in techniques for synthesizing virtual, graphic models of physical objects. Techniques such as generative adversarial networks (GANs) and variational autoencoders (VAEs) have proven successful in generating urban environments and specific, individual objects, such as human figures, including synthesis of models of people of different ages and poses.

GANs and VAEs generate encoder and decoder pairs, which are trained to minimize the error between the decoded data and the initial data. To facilitate synthesis of new assets (e.g., a dataset of 3D models) from initial data, the encoder encodes data to a compressed “latent space” format, which can be decoded by the decoder to create assets almost identical to the initial data. New values of latent space points can then be generated and decoded to create new assets that differ from the initial data.

Synthesized, photorealistic objects are useful for training recognition systems, as well as for developing realistic gaming systems. However, a lack of accuracy of current dataset generation techniques motivates a need for more efficient generation. Synthetic generation systems frequently suffer from quality issues, and may sacrifice photorealism to achieve variance.

### SUMMARY

Starting with a small dataset of 3D base models, each model including 3D mesh and texture feature map definitions, procedural modifications of the 3D meshes and the texture feature maps may be applied to generate new 3D models, thereby generating an augmented 3D model dataset. Next, a latent space is created by training a neural network autoencoder on the augmented 3D model dataset. The latent space is then tapped by random seeds, modified by a “sampler” neural network, that is trained to optimized uniqueness and variance, in order to generate a larger dataset of 3D models.

Embodiments of the present invention provide a computer-based system for large-scale generation of photorealistic 3D models, the system including a processor and a memory, the memory comprising instructions that when executed by the processor cause the processor to implement the following steps: First, texture map and 3D mesh autoencoder neural networks are trained, from a dataset of base 3D models, where the texture map and 3D mesh autoencoder neural networks include respective texture map and 3D mesh encoders, texture map and 3D mesh decoders, and texture map and 3D mesh latent spaces. Next, a sampler neural network is trained to convert random seeds into input vectors for the texture map decoder and the 3D mesh decoder, where training the sampler neural network includes selecting the random seeds from a normal distribution, feeding the random seeds to the sampler neural network, generating training 3D models from the texture map and 3D mesh decoders, rendering 2D images from the training 3D models, processing the 2D images by a realism classifier function and by a uniqueness function, and back-propagating the output of the realism classifier function and the uniqueness function to the sampler neural network. Finally, multiple additional random seed inputs are provided to the trained sampler neural network, to generate multiple respective input vectors for the texture map and 3D mesh decoders, which generate new 3D models from the input vectors.

In some embodiments, training the texture map and 3D mesh autoencoder neural networks includes providing, from the texture map decoder, L2 and KL loss functions for back-propagation, and providing, from the 3D mesh decoder, ICP and multi-view depth map loss functions for back-propagation.

Typically, the base 3D models are 3D models of human heads. A rendered image for the classifier function and for the uniqueness differentiator may be generated by a trained neural network renderer from a 3D model generated by merging the texture map decoder output and the 3D mesh decoder output.

In some embodiments, the dataset is an augmented dataset that includes base 3D models enhanced by a combination of texture maps of different 3D base models, and/or enhanced by procedural augmentation of 3D meshes, and/or enhanced by hierarchical combinations of 3D textures.

Alternatively, or additionally, the latent space may be trained hierarchically, such that a subset of dimensions of the vector space are zeroed proportionately to the resolution of the input 3D model.

There is also provided by embodiments of the present invention, a computer-based method for large-scale generation of photorealistic 3D models, implemented by a processor having a memory, the memory including instructions that when executed by the processor cause the processor to implement the method of: from a dataset of base 3D models, training texture map and 3D mesh autoencoder neural networks. The texture map and 3D mesh autoencoder neural networks typically include respective texture map and 3D mesh encoders, texture map and 3D mesh decoders, and texture map and 3D mesh latent spaces. The method further includes training a sampler neural network to convert random seeds into input vectors for the texture map decoder and the 3D mesh decoder. Training the sampler neural network may include selecting the random seeds from a normal distribution, feeding the random seeds inputs to the sampler neural network, generating training 3D models from the texture map and 3D mesh decoders, rendering 2D images from the training 3D models, processing the 2D images by a realism classifier function and by a uniqueness function, and back-propagating the output of the realism classifier function and the uniqueness function to the sampler neural network. The method further includes providing the trained sampler neural network with multiple additional random seed inputs to generate multiple respective input vectors for the texture map and 3D mesh decoders, and responsively generating by the texture map and 3D mesh decoders multiple respective new 3D models.

### BRIEF DESCRIPTION OF DRAWINGS

For a better understanding of various embodiments of the invention and to show how the same may be carried into effect, reference is made, by way of example, to the accompanying drawings. Structural details of the invention are shown to provide a fundamental understanding of the invention, the description, taken with the drawings, making apparent to those skilled in the art how the several forms of the invention may be embodied in practice. In the figures:

FIG. 1 is a flow diagram depicting a process for generating synthetic 3D models, in accordance with an embodiment of the present invention;

FIG. 2 is a flow diagram depicting a process of training neural network autoencoders for generating synthetic 3D models, in accordance with an embodiment of the present invention;

FIG. 3 is a flow diagram depicting a process of training a sampler neural network for sampling the latent space of the neural network autoencoders, in accordance with an embodiment of the present invention; and

FIG. 4 is a flow diagram, depicting a process of generating synthetic images with the sampler neural network, in accordance with an embodiment of the present invention.

### DETAILED DESCRIPTION

Embodiments of the present invention provide systems and methods for large-scale, computer generation of photorealistic 3D models. The 3D models may be synthetically generated representations of, for example, people's faces or heads. The 3D models may be defined as 3D meshes that define the 3D structure, the surface of which is “textured” by layers of texture maps. Hereinbelow, “large-scale” generation refers to generation of datasets of a hundred thousand and more 3D models. Photorealistic 3D models refer to models that when rendered to 2D images would appear to be photographs of real people.

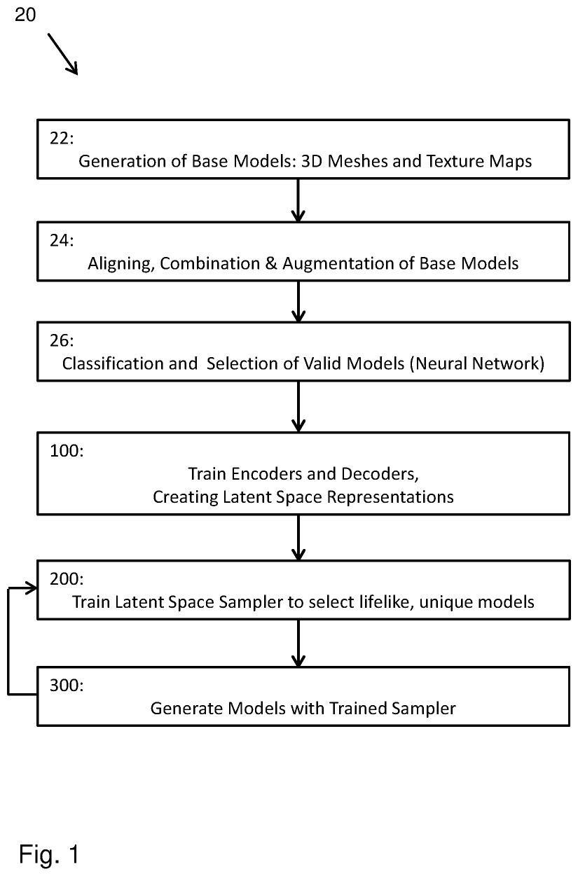

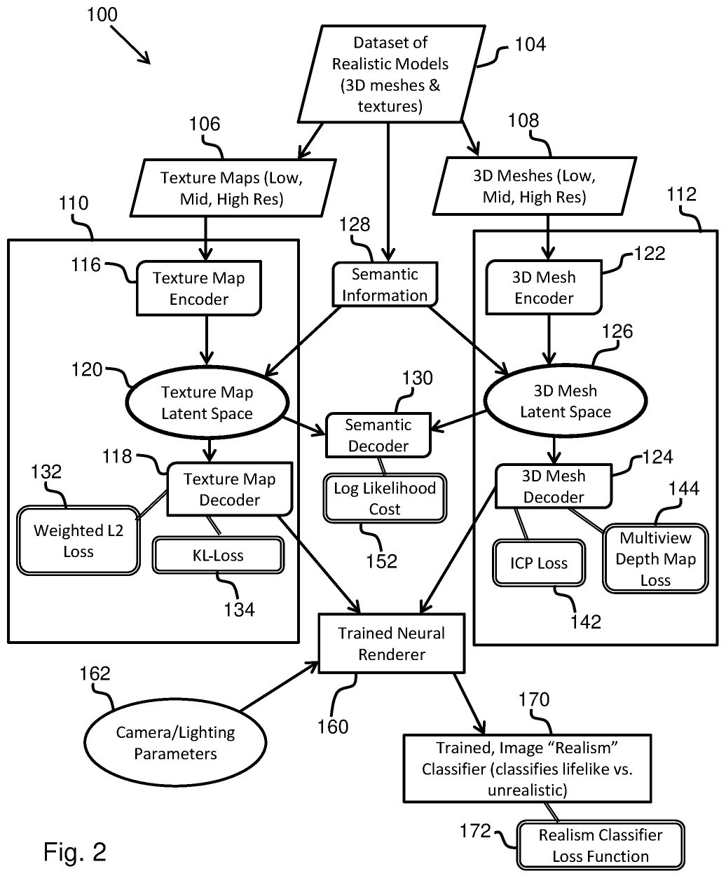

FIG. 1 is a flow diagram of a process 20 for generating synthetic 3D models, in accordance with an embodiment of the present invention. Process 20 includes six main steps: a step 22, which includes the generation of a dataset of base models (each base model defined by a 3D mesh and texture layers); a step 24, which includes the manipulation of base models to generate a larger dataset of augmented 3D models; a step 26, which includes the deletion of augmented 3D models that are not realistic; a step 100, which includes training of an autoencoder, using the augmented 3D models; a step 200, which includes training of a latent space sampler to select new points of the autoencoder latent spaces, in order to generate new 3D models; and a step 300, which includes generation of new 3D models by applying the trained latent space sampler to the autoencoder latent spaces. Steps 200 and 300 may be repeated, generating potentially millions of synthetic 3D models. The details of steps 100, 200, and 300 are described below with respect to FIGS. 2, 3, and 4, respectively.

The generation of base models (i.e., of 3D meshes and textures) at step 22 may be performed either by graphics artists, using 3D modelling programs (e.g., Unity, Blender, Maya, and/or 3DS Max) or by 3D scanning of real people or objects, with scanning technologies (such as GO!SCAN 3D, Artec3D, or Handscan3D). Graphics artists may follow the following steps when creating 3D models.
a. Sculpting of 3D structures is performed to create virtual 3D facial structures.
b. Photorealistic surfaces are created as skins for the 3D structures, typically using 2D modeling software. Such skins are typically created in multiple layers, called “texture layers.” Each texture layer is a 2D map. For human representations, the texture layers may include, for example, a person's skin color or the colors of a person's eyes.
c. Hair is created and then associated with 3D models of heads and bodies (such as creation of red curly head hair) and clothing and accessories are similarly created and associated.
d. Local imperfections in 3D meshes are removed using the 3D modeling programs.

The generation of 3D models of objects or of real people by scanning technologies, rather than by graphic artists, requires additional steps. The scanning software can automatically create a 3D “point cloud,” together with color information for each point in the point cloud. A 3D mesh software package may then be applied to iteratively connect points in the point cloud, creating a 3D mesh of triangles that enclose the point cloud.

Computational cleaning is then applied, by which noise from the raw scan is smoothed to reflect flatness of mesh surfaces. For 3D models of human faces, the cleaning may require smoothing of surface variations so that the final texture better reflects lifelike facial skin texture. Computational cleaning may include non-rigid registration of a scanned mesh to a base mesh having an approximate desired shape. The process typically includes minimizing the average distance between the base mesh and the scanned mesh set through an iterative optimization approach (e.g., hill climbing, stochastic gradient descent, or a genetic algorithm). Constraints on the resolution of this optimization produce a general 3D structure, while small 3D noise is ignored, such that the 3D structural information has substantially less noise. Typically, the optimization of a mesh of a face creates a mesh that is fully recognizable and the identity remains valid, while small points that were incoherent are removed.

A 3D artist may use tools such as ZBrush to create a single human face. During the modeling process, the artist may use a pen tablet and touch-sensitive displays. Similar to physically modeling with clay, the 3D artists may start with a simple sphere and carve out the 3D face model within the ZBrush program. For face models, the head shape may be modeled in 3D after which additional face parts are added. Ears/Nose/Chin are typically sculpted separately and connected to the head. Eye sockets are carved out of the head model. Eyeballs are created separately through a similar process. Details such as wrinkles and pores are sculpted manually on top of the rough initial face model. The following 8 steps are typical of a 3D design process:
1. Model the base shape (“clay” shape of head and face)
2. Create 2D details (e.g., in Photoshop)
3. Project details onto high polygon model carved from base shape
4. Create displacement and normal maps (displacement being difference between base model and high-poly model)
5. Create diffuse RGB texture (paint texture onto 3D model)
6. Create normal & displacement texture map layers
7. Create roughness map (“specular” map) layer
8. Create hair

The result of the initial modeling is a 3D model resembling a face. Texturing in step 7 may include creation of four texture map layers for each 3D model, to create a comprehensive photorealistic texture. These layers may be manually created. Texture map layers may include the following:

Map Layer 1: A standard color image (a “diffuse” map) representing facial colors is created by painting multiple layers of the skin zones and blood flow areas. The painting may be done in Photoshop or other similar 2D design software packages and projected onto the 3D model. Photoshop layers are added to represent various layers of skin details. After the base skin color is drawn, additional realism may be provided by layers that include pores, blemishes, etc. This is exported with zero effect of lighting and “cross-polarized”.

Map Layer 2: A roughness map is created to illustrate how the face reflects light. It simulates where a face “shines” more when interacting with light. This usually depends on where people sweat more and have more oil in their skin (i.e. forehead, chin, nose and lips, under the eyes, cheekbones). This is created by starting with a desaturated and darkened diffuse map (darkened by lowering the value channel in the HSV format). Top layers are added representing the oil of the skin in the relevant areas, based on skin anatomy. These multiple layers are then merged to create the roughness map.

Map Layer 3: A displacement map is created to simulate wrinkles and skin tension. Each porous area and wrinkle is created in a small separate map. Displacement is represented by an image of the width and height of the color texture image but with one dimension of “color” (i.e., a grayscale) representing the intensity of the 3D displacement at each point. There are usually 50-100 displacement maps per face. These are converted into “alpha” maps, which are small “grayscale” maps (i.e., having one value per pixel, as opposed to RGB maps, for example, which have three values per pixel). The alpha maps contain the height information of skin wrinkles and pores. The alpha map is projected onto the geometry using “drag brush” a tool within ZBrush program designed for this. The projection of all of the small maps onto the 3D mesh of the model aggregates the texture geometric information into a single map that augments the 3D model with fine geometric detail (that is, a “high-poly” map, meaning a large number of small polygons). The difference between a low-poly and high-poly representation is then converted to an image representation baking in all of the details.

Map Layer 4: A normal map is created, together with the displacement. This is a separate output that returns the 3D normal direction for displacement of each pixel. This is output from the same process as the displacement map creation, but instead of outputting the difference in height from the lower polygon model, the normal directions of each pixel is saved as a texture. This texture is output as a set of images. Each image is a representation of the normal vectors at each point on the texture.

After the texture layers are created, they are attached to the associated 3D model. Each 3D point on the 3D model is connected to a 2D point on each layer of the texture map. This is defined through standard algorithms within the 3D programs and is fine-tuned by the 3D artists. A 3D face model may thus be generated. 3D photorealistic models of eyes may be created through the same process as the face.

Hair may be generated using customized programs such as Blender, Maya and Houdini, which allow the 3D artists to define guidelines of hair bundles and then automatically generate random placement options around the guideline, retaining the same general shape and curvature of the hair. The style of the hair strands is separately defined in the programs, using a set of controls for the color and roughness, thickness and curliness of the hair.

After a set of base models is created, typically including both male and female models, of a variety of ages and races, the base models are manipulated by a range of defined procedures at step 24, to generate a larger dataset of augmented 3D models. The larger dataset is generated to enhance the variance in the dataset of 3D base models. The focus is on augmenting or adding small details to the models, for example to aspects of 3D models of human faces. Manipulation may include “hierarchical combining” of 3D models, i.e., mixing features of the base models. This may be done, for example, by creating a weighted average of randomly selected texture maps from the base models' texture maps. For example, given K (e.g., 5) texture maps, pixel values for each given pixel location are averaged. The output of this averaging would be a new texture map, which could be applied to create a new 3D model. After the combination, the newly generated texture maps and corresponding 3D meshes are added to the original dataset of base 3D models. This expands the base model dataset, enhancing the dataset variance. The greater level of variance improves the variance of the subsequently generated autoencoder, which is trained using the augmented dataset (at step 100).

Manipulation of the 3D models may also include augmentation involving the creation of skin artifacts and imperfections, with random placement, size and coloring.

Many skin artifacts and imperfections may be initially created by artists or scanned. Constraints on size, body location, and coloring may then be defined, according to the object modeled. For example, on 3D face models, a constraint may specify that beauty marks may be applied to the face and neck but not applied to the eyes. Randomly generated artifacts may then be applied. Augmentations may also be defined for various face and body properties, for example: augmenting the nose to be wider/thinner, larger/smaller, more crooked/straighter. These augmentations may then be applied to the body at random, creating addition variance between the modelled objects.

Next, at step 26, the augmented 3D models may be reviewed by manual or automated methods to remove augmented models that are not realistic. Random manipulation of variables of 3D meshes and of texture maps, as described above, may generate models that are not representative of actual human anatomy or appearance. An example would be a model of a person with a small face, a huge nose, and eyes that are exceptionally far from each other. A person with such features may actually exist, but the probability is very low. If most of the dataset includes such non-realistic models, an autoencoder based on the dataset will be less likely to generate 3D models that look like typical people (i.e., people with “realistic” features.). To properly prepare the training of the autoencoder at step 200, the filtering step 26 performs a filtering of the augmented 3D models so as to only include “realistic” 3D models.

FIG. 2 is a flow diagram, depicting the process 100 of training a neural network for generating synthetic 3D models, in particular facial models, in accordance with an embodiment of the present invention. In typical embodiments, process 100 includes training variational auto-encoders, which are types of generative, deep-learning, neural networks. At step 100, an autoencoder is trained to generate new 3D models based on randomly generated seed values, referred to herein as a latent space sampler. The latent space sampler is trained at step 200, and then applied to generate new models at step 300.

The first step of process 100 is to extract, from a dataset 104 of filtered, augmented, 3D models, as described above, texture maps 106 and 3D meshes 108. These “assets” are extracted separately, to be applied in training, respectively, a texture map autoencoder 110, and a 3D mesh autoencoder 112, both autoencoders typically being variational neural network autoencoders. In some embodiments, the augmented dataset 104 may include approximately 10,000 3D models, which have been generated from a base 3D dataset of, for example, 200-300 base models.

### Texture Map Latent Space

The texture map autoencoder 110 includes a texture map encoder 116 and a texture map decoder 118, which are both neural networks trained in unison to generate a texture map latent space 120. The 3D mesh autoencoder 112 includes a 3D mesh encoder 122, and a 3D mesh decoder 124, neural networks trained in unison to generate a texture map latent space 126. Semantic labels of the 3D models, such as sex, race, and age, may also be stored in the latent spaces, and decoded by a semantic decoder 130.

As described above, each model may have multiple texture map layers. In some embodiments, all layers have widths and heights of 2000×2000 pixels, each with their respective color channels. Dimensions of the texture map layers may be as follows:

The diffuse map layer may have dimensions of 2000×2000×3 pixels.

The displacement map layer may have dimensions of 2000×2000×1 pixels.

The roughness map layer may have dimensions of 2000×2000×1 pixels.

The normal map layer may have dimensions of 2000×2000×3 pixels.

Combining layers gives input dimensions of 2000×2000×8. This is what is learned and mimicked by the texture map autoencoder. The pixel values may be normalized between 0 and 1, each type of layer being normalized separately. The normal map layer may be normalized such that the three dimensions sum to one. The diffuse (color RGB) map may be normalized between 0 and 1 instead of 0 and 255 (example: an image pixel of color [255, 100, 0] is converted to [1.0, 0.392, 0.0]. This normalization allows the network to learn faster than it would without normalization. A basic version of a texture map encoder neural network architecture may include the following network layers:
Layer 1: Convolution—input: 2000×2000×8, output: 2000×2000×16+
Layer 2: Downsample—input: 2000×2000×16, output: 500×500×16
Layer 3: Convolution—input: 500×500×16, output: 500×500×16+ReLU
Layer 4: Downsample—input: 500×500×16, output: 200×200×16
Layer 5: Convolution—input: 200×200×16, output: 200×200×32+ReLU
Layer 6: Downsample—input: 200×200×32, output: 50×50×32->conversion to 250×32
Layer 7: Convolution—input: 250×32, output: 250×64+ReLU
Layer 8: Downsample—input: 250×64, output: 50×64
Layer 7: Convolution—input: 50×64, output: 50×64+ReLU
Layer 8: Downsample—input: 50×64, output: 10×64
Layer 9: Fully Connected—input: 10×64 output 32
Layer 10: Sampling Layer—input 32, output: 32 (sample from Normal Distribution, assert mean representation, assert variance representation, combine)

The texture map decoder neural network architecture may include the following network layers:
Layer 1: Fully Connected—input: 32, output: 10×64
Layer 2: UpSample—input: 10×64 output: 50×64
Layer 3: Convolution—input: 50×64 output: 50×64+ReLU
Layer 4: UpSample—input: 50×64, output: 250×64
Layer 5: Convolution—input: 250×64, output: 250×32->conversion to 50×50×32
Layer 6: UpSample—input: 50×50×32, output: 200×200×32
Layer 7: Convolution—input: 200×200×32, output: 200×200×16
Layer 8: UpSample—input: 200×200×16, output: 500×500×16
Layer 7: Convolution—input: 500×500×16, output: 500×500×16
Layer 8: UpSample—input: 500×500×16, output: 2000×2000×16
Layer 9: Convolution—input: 2000×2000×16, output: 2000×2000×8

Like the input, the output may be normalized, in which case a de-normalization stage must be applied. This converts each map to its expected range. For example, a color layer output of [1.0, 0.392, 0.0] is converted to [255, 100, 0].

The texture maps may be represented as vectors of 32 dimensions, which rely on information stored within the weights of the neural network used to encode the texture maps. In some embodiments, the autoencoder may be trained for 1800 epochs with a learning rate of 7e-3 and a learning rate decay of 0.997 every epoch.

Two different loss functions may be used for back-propagation to train the texture map autoencoder, a weighted L2 (square-integrable) loss function 132, and a Kullback—Leibler divergence (KL) loss function 134. A stochastic gradient descent with a momentum of 0.92 may be used to optimize the weighted L2 loss function 132, which measures the loss between a predicted image set and the original image set. That is, the weighted L2 loss function is a standard image-to-image loss, which may be determined as a pixel-to-pixel loss squared function, allowing the neural network to focus on pixel values of the image that are expected to be returned from the decoder. The L2 loss is also known as the reconstruction loss, as it attempts to minimize reconstruction error at a pixel level.

The KL loss function 134 may be used for training. This function enforces a unit Gaussian prior N (0, 1) with zero mean on the distribution of latent space vectors, meaning that this forces the latent space to be a multivariate, regular Gaussian distribution. Note that each value in the latent space is represented as a mean and variance.

The weights of the texture map neural network represent a function that maps the high-dimensional input into the lower dimensional representation of the latent space, which has a normal distribution. The lower dimensional representation is input into the decoder, which has neural network weights to map from the low dimensional representation back to the high-dimensional size of the data. That is, the encoder learns to condense and the decoder learns to transform the condensed representation back into the original data. 3D Mesh Latent Space

In some embodiments, each input 3D mesh is defined with the same number of vertices, such as 10 k vertices. The input and output dimensions of each layer of the encoder and decoder neural networks may be implemented with an open source neural network library (e.g., TensorFlow or PyTorch).

One implementation of the 3D mesh encoder architecture may have the following neural network layers:
Layer 1: Convolution—input: 10,000×3, output: 10,000×16+ReLU
Layer 2: Downsample—input: 10,000×16, output: 2,000×16
Layer 3: Convolution—input: 2,000×16, output: 2,000×32+ReLU
Layer 4: Downsample—input: 2,000×32, output: 400×32
Layer 5: Convolution—input: 400×32, output: 400×32+ReLU
Layer 6: Downsample—input: 400×32, output: 40×32
Layer 7: Convolution—input: 40×32, output: 40×64+ReLU
Layer 8: Downsample—input: 40×64, output: 10×64
Layer 9: Fully Connected—input: 10×64 output 16
Layer 10: Sampling Layer—input 16, output: 16
(Sample from Normal Distribution, assert Mean representation, assert variance representation, combine)

An implementation of the 3D mesh decoder architecture may have the following layers:
Layer 1: Fully Connected—input: 16, output: 10×64
Layer 2: UpSample—input: 10×64 output: 40×64
Layer 3: Deconvolution—input: 40×64 output: 40×32+ReLU
Layer 4: UpSample—input: 40×32, output: 400×32
Layer 5: Deconvolution—input: 400×32, output: 400×32
Layer 6: UpSample—input: 400×32, output: 2000×32
Layer 7: Convolution—input: 2000×32, output: 2000×16
Layer 8: UpSample—input: 2000×16, output: 10000×16
Layer 9: Convolution—input: 10000×16, output: 10000×3

The output dimension is equal to the input dimension. In one embodiment, the autoencoder is run for 720 epochs with a learning rate of 6e-3 and a learning rate decay of 0.995 every epoch. A stochastic gradient descent may be used with momentum of 0.9, for example, in order to minimize the difference (i.e., the loss) between the predicted mesh and the original mesh. The difference may be calculated as by the Iterative Closest Point (ICP) algorithm (referred to as “L1 loss”) or by the Euclidean distance (L2 loss).

The loss functions for training the 3D mesh architecture (i.e., by back-propagation) may include an ICP loss function 142 and a multi-view depth loss function 144. ICP loss is calculated by calculating the closest point on each point of an output 3D mesh and averaging with the closest point on the input 3D mesh. When the input and output are identical, the “loss” is zero. When the models are very different, the loss is large. The multi-view depth loss 144 is calculated as follows. Multiple synthetic viewpoints of a 3D mesh are captured and converted to depth maps. L2 distances between synthesized depth images and calculated depth images are then calculated. That is, the depth maps are compared with synthesized viewpoints of the mesh, reconstructed after the discriminator.)

Various semantic high level features are defined for each of the generated 3D models before the latent space stage. Gender, age group, ethnicity, emotion, weight profile (skinny/fat), etc. are all high level metadata describing of aspects of each 3D model. Each 3D model is associated with such “semantic information,” that is, with such metadata. The semantic decoder 130 is a classification neural network trained to utilize the condensed latent space information to automatically return this metadata. This enforces the network to reprocess these high level semantic qualities in additional models sampled by the latent space. This is important; otherwise many of the combinations would fall between genders and ethnicities, in a way that is not represented in the real-world population. The loss function for this process is typically a log likelihood cost function 152.

An additional cost function used for training the autoencoders is based on classifying whether images rendered from the generated 3D models look realistic. For 3D model input, an image renderer 160 merges the resulting output from the texture map and 3D mesh decoders to generate a full 3D model output, and then renders one or more images from the full 3D model. The renderer may be a pre-trained neural network renderer, which may also receive preset camera and lighting parameters 162.

Rendered images are fed to a pre-trained realism classifier 170, which classifies the realism of the images. A realism loss function 172, indicating an extent of real or synthetic appearance of the images, is back-propagated to help the neural network converge into a more realistic result. That is, the loss function is back-propagated to the latent space representation as well as to the encoder and decoder networks that define it. This reinforces the realism and stops artifacts such as marks and blurs from being generated.

Hierarchical Latent Space Training

In some embodiments, the training of the autoencoders is structured in a hierarchical manner that maps the encoding to the latent space according to the resolution of the input 3D models. The neural network latent space representation is trained with the same input being input at different resolutions, where a subset of the vector dimensions are zeroed. More dimensions of the vector are zeroed for lower levels of resolution. Muting out these dimensions, in proportion to the resolution/vertices of the texture/3D models that are input into the network, forces the network to learn the latent space information in an order that is sorted from coarse to fine detail. This ordered representation permits subsequent augmentation of coarse information without affecting fine details. For example, a shape of a head could be changed without affecting fine skin details, such as skin blemishes. Conversely, fine details may be changed without affecting larger features (i.e., birthmarks may be changed without changing the skin color). In some embodiments, three levels of resolution are applied, high, medium, and low. At high resolution, all vector elements of the encoder output may be trained. At medium resolution, some vector elements may be muted (or “zeroed”) to prevent them from changing, and at low resolution, more elements may be muted.

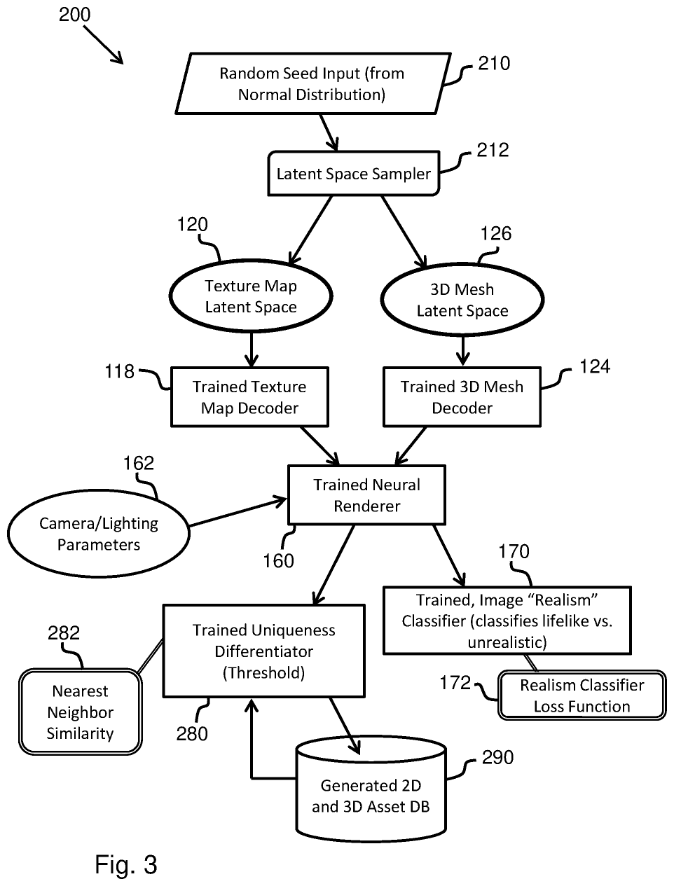

FIG. 3 is a flow diagram, depicting the process 200 of training a “sampler” neural network 212 for sampling the texture map latent space 120 and the 3D mesh latent space 126 to generate new 3D models (by the respective trained texture map decoder 118 and the trained 3D mesh decoder 124), in accordance with an embodiment of the present invention. The sampler neural network 212 is trained to generate a latent space sampling vector from a random seed input 210. The random seed may be, for example, a value randomly chosen from a normal distribution. The sampler is trained to generate 3D models from the continuous latent spaces so as to increase the probability of generating realistic (i.e., “lifelike”) 3D models while also increasing the variation of generated 3D models. Simply sampling randomly from the latent space would create many models, but likely would create many models that would be almost identical.

To train the sampler neural network 212 to generate 3D models that are both realistic and have a high variation, two loss functions are applied to the 3D model generation process. First, the realism of generated models is trained with the same realism classifier 170 used to train the autoencoders in process 100 described above. For each 3D model generated by a random seed 210 (by merging the texture map decoder and 3D mesh decoder outputs), the pre-trained neural network renderer 160, configured with the preset camera and lighting parameters 162, creates a rendered image. The rendered images are applied to the pre-trained realism classifier 170, and a loss function indicating an extent of realistic appearance is back-propagated to the sampler neural network 212.

In addition, a pre-trained, neural network uniqueness differentiator 280 is configured to generate a training function, specifically a nearest neighbor similarity function 282. The uniqueness differentiator is trained to create a condensed representation of the rendered images. The uniqueness differentiated may be modelled after existing facial recognition systems, such as DeepFace, by Facebook, which can determine whether a 2D facial image is represented by any images that are already in a database, the output being a probability of a match. Subsequently, for each new 3D model generated and rendered, the uniqueness differentiator calculates the average “nearest neighbor” Euclidian distance to the closest image representation already in the condensed representation. The sampler neural network 212 is trained to maximize the results of the nearest neighbor function, in other words, configuring the network to sample regions of the latent space that produce the most different/unique models. A loss maximizing the uniqueness (or the distance between the identity of the generated model and the identities of the nearest models in the db is created). Two models may be considered of the same identity if the Euclidean distance between the two is below a given threshold. This can be calibrated per dataset according to a level of sensitivity that may be preset.

The 3D models, as well as the rendered images, may then be saved in a 2D/3D model database 290 (each new 3D model, together with its rendered images, being added to the database). Images may be saved in an aligned format, that is, with alignment of main facial features, with the application of identical camera and lighting parameters simplifying the alignment process.

Training of the sampler neural network may be performed by, for example, applying in the range of one thousand random seed values that follow a normal distribution.

A typical architecture of the sampler neural network may include three layers of fully convolutional neural network, as follows:

Layer 1: Input 1000 (randomly generated seed values from a normal distribution), Output 500, leaky rectified linear unit (ReLU);

Layer 2: Input 500, Output 500, Leaky ReLU

Layer 3: Input 500, Output (vector of the size of the model latent space plus the texture latent space). As an example, if 3D models are represented in the 3D mesh latent space as vectors of 192 dimensions (i.e., vectors of 192 elements), and in the texture latent space as vectors of 100 dimensions, the output layer of the sampler neural network would be a vector of 292 dimensions.

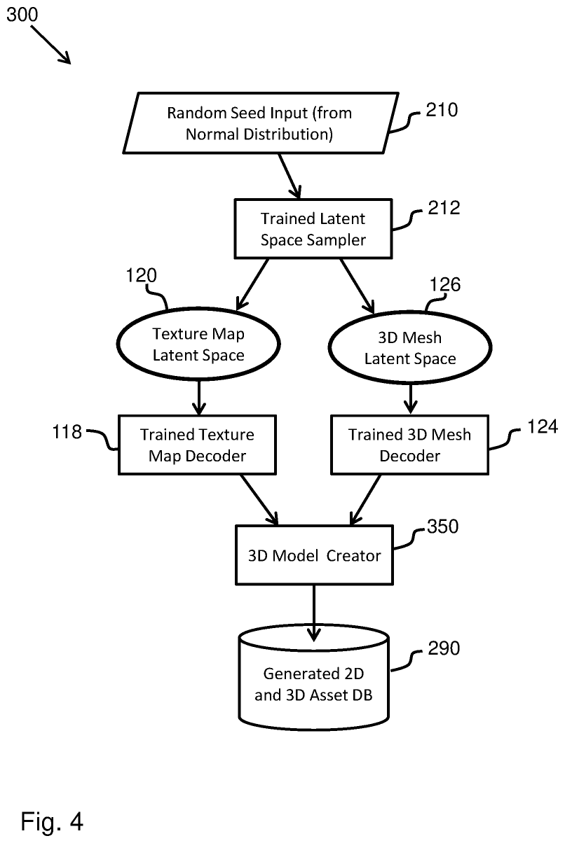

FIG. 4 is a flow diagram, depicting a process of generating synthetic images with a trained sampler neural network 212 (also referred to herein as the “latent space sampler”), in accordance with an embodiment of the present invention. Once the sampler neural network 212 is trained according to process 200, new 3D models may be generated by applying random seeds to the sampler, which selects points in the texture map and 3D mesh latent spaces (120 and 126), which are then decoded by the respective texture and 3D mesh decoders (118 and 124). A 3D model creator 350 creates 3D models from the generated texture maps and 3D meshes, which are then stored in the database 290. Rendered images may also be created and stored for subsequent retraining of the sampler neural network.

The sampler neural network may be retrained to have new weights, primarily to reduce the tendency of new 3D models to look like previously generated 3D models. Sampling then continues. This constantly produces new 3D models that are both highly diverse and unique. That is, the sampler learns the new distribution of unique models within the database (reducing generation of new 3D models resembling models that were already generated). The sampler may be configured to be retrained after a threshold number of 3D models have been generated. The threshold may be set, for example, in the range of several hundred to several thousand. Alternatively, the uniqueness differentiator may be operated in parallel with process 300, such that retraining is performed whenever the average “uniqueness” of 3D models drops too low. For example, examples of pairs of similar people can be used to calibrate “uniqueness”. A measure of the differences between such people may set a minimum threshold for uniqueness. Subsequently, any two 3D models that are more similar to each other than the similarity threshold are considered non-unique. If a number of randomly selected generated models are non-unique, the sampler model is re-trained.

Based on the process described herein, a 3D model dataset of human faces has been generated with more than a million unique 3D models.

The sampler neural network is typically relatively small (i.e., has few layers) in order to allow for quick re-training times otherwise it becomes infeasible to reach scale. The network can be designed, for example as a 4 layer CNN with 2 fully connected (FC) layers at the end.

The system may be an add-on, or upgrade, or a retrofit to a commercial product for image recognition. Processing elements of the system described herein may be implemented in digital electronic circuitry, or in computer hardware, firmware, software, or in combinations thereof. Such elements can be implemented as a computer program product, tangibly embodied in an information carrier, such as a non-transient, machine-readable storage device, for execution by, or to control the operation of, data processing apparatus, such as a programmable processor, computer, or deployed to be executed on multiple computers at one site or one or more across multiple sites. Memory storage for software and data may include multiple one or more memory units, including one or more types of storage media. Examples of storage media include, but are not limited to, magnetic media, optical media, and integrated circuits such as read-only memory devices (ROM) and random access memory (RAM). Network interface modules may control the sending and receiving of data packets over networks. Method steps associated with the system and process can be rearranged and/or one or more such steps can be omitted to achieve the same, or similar, results to those described herein.

It is to be understood that the embodiments described hereinabove are cited by way of example, and that the present invention is not limited to what has been particularly shown and described hereinabove.

What is claimed:

1. A computer-based system for large-scale generation of photorealistic 3D models, comprising a processor and a memory, the memory comprising instructions that when executed by the processor cause the processor to implement steps of:
from a dataset of base 3D models, training texture map and 3D mesh autoencoder neural networks, wherein the texture map and 3D mesh autoencoder neural networks include respective texture map and 3D mesh encoders, texture map and 3D mesh decoders, and texture map and 3D mesh latent spaces;
training a sampler neural network to convert random seeds into input vectors for the texture map decoder and the 3D mesh decoder, wherein training the sampler neural network comprises selecting the random seeds from a normal distribution, feeding the random seeds to the sampler neural network, generating training 3D models from the texture map and 3D mesh decoders, rendering 2D images from the training 3D models, processing the 2D images by a realism classifier function and by a uniqueness function, and back-propagating the output of the realism classifier function and the uniqueness function to the sampler neural network; and
providing the trained sampler neural network with multiple additional random seed inputs to generate multiple respective input vectors for the texture map and 3D mesh decoders, and responsively generating by the texture map and 3D mesh decoders multiple respective new 3D models.

2. The system of claim 1, wherein training the texture map and 3D mesh autoencoder neural networks comprises providing, from the texture map decoder, L2 and KL loss functions for back-propagation, and providing, from the 3D mesh decoder, ICP and multi-view depth map loss functions for back-propagation.

3. The system of claim 1, wherein the base 3D models are 3D models of human heads.

4. The system of claim 1, wherein a rendered image for the classifier function and for the uniqueness differentiator is generated by a trained neural network renderer from a 3D model generated by merging the texture map decoder output and the 3D mesh decoder output.

5. The system of claim 1, wherein the dataset is an augmented dataset that includes base 3D models enhanced by a combination of texture maps of different 3D base models.

6. The system of claim 1, wherein the dataset is an augmented dataset that includes base 3D models enhanced by procedural augmentation of 3D meshes.

7. The system of claim 1, wherein the dataset is an augmented dataset that includes base 3D models enhanced by hierarchical combinations of 3D textures.

8. The system of claim 1, wherein the latent space is trained hierarchically, such that a subset of dimensions of the vector space are zeroed proportionately to the resolution of the input 3D model.

9. A computer-based method for large-scale generation of photorealistic 3D models, implemented by a processor having a memory, the memory including instructions that when executed by the processor cause the processor to implement the method of:
from a dataset of base 3D models, training texture map and 3D mesh autoencoder neural networks, wherein the texture map and 3D mesh autoencoder neural networks include respective texture map and 3D mesh encoders, texture map and 3D mesh decoders, and texture map and 3D mesh latent spaces;
training a sampler neural network to convert random seeds into input vectors for the texture map decoder and the 3D mesh decoder, wherein training the sampler neural network comprises selecting the random seeds from a normal distribution, feeding the random seeds inputs to the sampler neural network, generating training 3D models from the texture map and 3D mesh decoders, rendering 2D images from the training 3D models, processing the 2D images by a realism classifier function and by a uniqueness function, and back-propagating the output of the realism classifier function and the uniqueness function to the sampler neural network; and
providing the trained sampler neural network with multiple additional random seed inputs to generate multiple respective input vectors for the texture map and 3D mesh decoders, and responsively generating by the texture map and 3D mesh decoders multiple respective new 3D models.

10. The method of claim 9, wherein the base 3D models are 3D models of human heads.
